(19) United States
(12) Patent Application Publication
(10) Pub. No.: US 2019/0022975 A1
(43) Pub. Date: Jan. 24, 2019

(54) Substrate with Graphene-Based Layer

(71) Applicant: Brown University, Providence, RI (US)

(72) Inventors: Robert Howard Hurt, Providence, RI (US); Ian Yan Wong, Providence, RI (US); Po-Yen Chen, New Taipei City (TW)

(21) Appl. No.: 16/043,216

(22) Filed: Jul. 24, 2018

Related U.S. Application Data
(60) Provisional application No. 62/536,129, filed on Jul. 24, 2017.

(51) Int. Cl. B32B 9/04; B32B 27/36

(52) U.S. Cl. CPC B32B 9/045; B32B 27/36; B32B 2307/7242; B32B 2571/00; B32B 2313/04; B32B 2437/00; B32B 2255/20

(57) ABSTRACT

The present invention is directed to a stretchable graphene-based barrier layer on an elastomeric substrate.

### STATEMENT OF GOVERNMENT INTERESTS

This invention was made with government support under grant no. P42 ES013660 awarded by the National Institutes of Health and grant no. 1132446 awarded by the National Science Foundation. The government has certain rights in the invention.

### FIELD

The present disclosure relates to the use of a graphene-based layer as a barrier to permeants.

### BACKGROUND

Approaches for managing toxic substances include capture and removal, destruction, chemical transformation to low-toxicity products, and source containment. In many practical scenarios, containment is the technology of choice due to cost and simplicity. The containment approach typically relies on engineered barriers that prevent or inhibit toxicant transport to the open environment or to compartments where exposures are more likely for humans or sensitive environmental receptors.

The containment approach encompasses a wide range of technologies that include personal protective equipment for workers or military personnel, geomembranes for landfill liners and caps (see Rowe, R. K., Barrier systems for waste disposal facilities. 2nd ed.; Spon Press: New York, 2004), sealants for surfaces containing lead paint, architectural vapor barriers to protect buildings from the intrusion of radon or volatile organic compounds, vertical subsurface barriers that are either passive (see Filz, G. M.; Widdowson, M. A.; Little, J. C., Barrier-controlled monitored natural attenuation, Environ. Sci. Technol. 2001, 35, (15), 3225-3230) or reactive, (see Shimotori, T.; Nuxoll, E. E.; Cussler, E. L.; Arnold, W. A., A polymer membrane containing Fe-0 as a contaminant barrier, Environ. Sci. Technol. 2004, 38, (7), 2264-2270), in situ sediment caps (see McDonough, K. M.; Murphy, P.; Olsta, J.; Zhu, Y.; Reible, D.; Lowry, G. V., Development and Placement of a Sorbent-Amended Thin Layer Sediment Cap in the Anacostia River, Soil and Sediment Contamination: An International Journal 2007, 16, (3), 313-322) sealants or coatings to suppress indoor formaldehyde release from manufactured wood products or construction products such as drywall, or tarps as transport barriers for soil fumigants (see Wang, D.; Yates, S. R.; Ernst, F. F.; Gan, J.; Jury, W. A., Reducing methyl bromide emission with a high barrier plastic film and reduced dosage. Environ. Sci. Technol. 1997, 31, (12), 3686-3691.) Suppressing the transport or release of toxicants is also important in shipping and recycling of wastes containing volatile mercury (see Johnson, N. C.; Manchester, S.; Sarin, L.; Gao, Y. M.; Kulaots, I.; Hurt, R. H., Mercury vapor release from broken compact fluorescent lamps and in situ capture by new nanomaterial sorbents, Environ. Sci. Technol. 2008, 42, (15), 5772-5778 and Lee, B.; Sarin, L.; Johnson, N. C.; Hurt, R. H., A Nano-Selenium Reactive Barrier Approach for Managing Mercury over the Life-Cycle of Compact Fluorescent Lamps, Environ. Sci. Technol. 2009, 43, (15), 5915-5920.) which permeates through most bag and box materials, and in food and pharmaceutical packaging, where inks, monomers, and plasticizers can leach through or from the polymer packaging into the product. Improved barrier fillers or inner linings may be able to reduce the amount of leachable or extractables that find their way into foods and drugs.

Many synthetic barriers are based on polymers, and most commodity polymers are not effective barriers to small molecule permeation, especially in the vapor phase.

Accordingly, it is an object of the present disclosure to improve the barrier performance of polymers and other substrates. It is a further object of the present disclosure to provide environmental containment barriers to toxicant transport. It is a still further object of the present disclosure to provide barriers to toxicant or other small molecule transport that are wearable by an individual. It is a still further object of the present disclosure to provide barriers to toxicant and other small molecule transport for use in the home or building construction industry. It is a still further object of the present disclosure to provide barriers to toxicant and other small molecule transport for use in the packaging or shipping industries. It is a still further object of the present disclosure to provide barriers to toxicant and other small molecule transport for use in the food packaging industry. It is a still further object of the present disclosure to provide barriers to toxicant and other small molecule transport for use in the drug or pharmaceutical packaging industry.

These and other objects, features, and advantages described in the present disclosure will be apparent to those skilled in the art from the following disclosure and description of exemplary embodiments.

### SUMMARY

Embodiments of the present disclosure are directed to environmental containment barriers formed from a substrate and a graphene-based layer disposed thereon. The graphene-based layer provides a barrier to the transport of small molecules, such as toxicants and vapors commonly found in landfills and other environmental conditions or environmentally hazardous conditions.

The graphene-based layers disclosed herein can be used to protect humans or the environment from toxicants. Accordingly, aspects of the present disclosure are directed to particular methods and applications utilizing graphene-based layers to either contain small molecules within a given location, such as a large scale environmentally hazardous condition, or to separate or isolate small molecules from a given environment, such as with a wearable hazardous material suit.

Aspects of the present disclosure are directed to the physical structure of the graphene-based layers disclosed herein and to methods of making such graphene-based layers. According to one aspect, the graphene-based layers have a given interlayer spacing and are formed by overlapping individual graphene-based sheets. The graphene-based sheets may be functionalized to allow crosslinking between the graphene-based sheets using low molecular weight or short crosslinkers to allow for a minimal interlayer spacing that is smaller than many small molecule toxicants. Accordingly, one aspect of the present disclosure is a graphene-based layer reinforced with crosslinking agents yet is impermeable or substantially impermeable to small molecule toxicants.

Aspects of the present disclosure are also directed to the surface modification of substrates onto which graphene-based layers are provided. According to one aspect, the surface of the substrate is treated to render it more hydrophilic. An aqueous based formulation including individual graphene-based planar sheets may then be more uniformly deposited across the surface of the substrate. Accordingly, a continuous or substantially continuous graphene-based layer may be created at relatively low mass loadings. According to one aspect, the surface of the substrate is treated to render it more cationic or electropositive. Individual planar sheets of graphene oxide and other types of graphene being relatively anionic or electronegative are then more readily adhered to the surface of the substrate.

Aspects of the present disclosure are further described with respect to the following brief description of the drawings.

### BRIEF DESCRIPTION OF THE DRAWINGS

FIG. 1A is an image of graphene oxide sheets deposited on a mica surface.

FIG. 1B is an atomic force microscope section analysis showing thickness of graphene oxide sheets.

FIG. 2A is an image of graphene oxide sheets on a scale of 3 μm.

FIG. 2B is an image of graphene oxide sheets on a scale of lam.

FIG. 3 is a graph of intensity versus zeta potential as an indication of dispersibility of graphene oxide sheets in water.

FIG. 4 is a schematic of a glass mercury vapor diffusion cell used to measure mercury vapor permeability of substrates with a graphene oxide layer described herein.

FIG. 5 is a graph showing steady state concentration of mercury vapor above polymer membranes in the glass mercury vapor diffusion cell of FIG. 4. Permeability calculations are based on the final steady state values.

FIG. 6 is a graph of measured mercury vapor permeability coefficients (solid markers) for common commercial polymer sheet materials. Literature values for small gases in the same materials are included for comparison.

FIG. 7 is a graph showing effectiveness of thin graphene oxide films as Hg-vapor barrier enhancers on 50 μm thick polyester films. The graphene oxide film configuration is seen to be much more effective than the common configuration with GO uniformly mixed (compounded) with the polymer (Nielsen model). The data lie between the Nielsen ideal imbedding limit and the limit for random overlapping disks whose centers of mass deposit on the film by a Poisson process. For the modeling, the atomic GO thickness was taken as 1 nm and the lateral dimension 0.5 μm. Image shows polyester film treated with GO film (right) and untreated (left).

FIG. 8 is a graph showing permeability of films dried at room temperature at 15% relative humidity for 48 hours (left), and at approximately 70° C. with zero relative humidity for 48 hours (right).

FIG. 9A is a graph showing pressure drop during forced filtration through nanochannel alumina filters (20 nm pore size) for graphene oxide compared to carbon black material and carbon nanotubes, which form three-dimensional porous filter cakes.

FIG. 9B are SEMs showing structure of deposited films or porous filter cakes.

FIG. 9C is a graph showing concentration dependence of sealant effect for graophene oxide and Nylon filters. Label “blocking” refers to a control experiment in which the syringe was capped.

FIG. 9D is a unification of the data in FIG. 5C renormalizing X-axis as the total mass of graphene oxide deposited (M=C·V_{filtration}).

FIG. 10A depicts graphene oxide surface topography at various stages of stretching of an elastomeric substrate.

FIG. 10B depicts permeation data of various solvents.

FIG. 10C depicts permeation data for TCE.

FIG. 11A depicts surface morphology of crumpled GO films after various cleaning processes.

FIG. 11B depicts the concept of using wrinkled GO barrier layers on stretchable substrates.

FIG. 11C depicts a method for making a wrinkled stretchable GO barrier layer on a stretchable substrate.

FIG. 11D depicts the barrier nature of the wrinkled stretchable GO barrier layer on a stretchable substrate.

### DETAILED DESCRIPTION OF CERTAIN EXEMPLARY EMBODIMENTS

Embodiments of the present disclosure are directed to a barrier layer having graphene-based planar sheets aligned substantially parallel to one another and having substantially contiguous overlapping planar sheet faces. The graphene-based planar sheets may be graphene or functionalized graphene such as graphene oxide. Functional groups which may be present on graphene-based planar sheets include oxygen-containing functional groups such as hydroxy, epoxy, carboxy, carbonyl, lactone and the like. One example of a graphene-based planar sheet is functionalized graphene such as graphene including oxygen-containing functional groups. Exemplary graphene-based planar sheets include graphene, graphene oxide or reduced graphene oxide known to those of skill in the art. Functional groups which may be present on functionalized graphene sheets include sulfonate, thiol, amine, alkylamine, phosphate, nitrate and the like or oligomers such as polyethylene glycol or polyethylene glycol derivatives with carboxy, amino, hydroxyl or other terminal groups.

According to one aspect, the graphene-based layer acts as a barrier to the movement of small molecules from one side of the graphene-based layer to the other side of the graphene-based layer. Accordingly, the graphene-based layer has particular application where containment of toxicants, particularly small molecule toxicants, is desirable. The term containment includes isolating small molecules to a particular area. Accordingly, the graphene-based layer has particular application where separation of toxicants, particularly small molecule toxicants, from a particular environment is desirable. It is to be understood that containment and separation may be used interchangeably herein as each involves separating small molecules, such as small molecule toxicants, from a particular environment.

According to certain aspects, the barrier layer of the present disclosure is flexible, i.e., non-rigid, such that the barrier layer may be flexed or bent or moved relative to itself without the barrier layer breaking or separating so as to be non-continuous. The flexible barrier may be placed on a flexible substrate. An example of a flexible substrate is a flexible polymer sheet than can conform to a particular geometry of an object or location over which the flexible sheet may be placed to form a barrier to small molecules, such as small molecule toxicants.

Barrier layers within the scope of the present disclosure may have a layer thickness of between about 5 nm and about 200 nm, between about 10 nm and about 150 nm, between about 20 nm and about 100 nm, between about 20 nm and about 80 nm, and all ranges and values in between whether expressly recited or not.

According to one aspect, the barrier layers include a plurality of graphene-based planar sheets. The graphene-based planar sheets have a lateral dimension of between about 0.1 μm to about 5 μm, between about 0.5 μm to about 4.5 μm, between about 1.0 μm to about 4.0 μm, between about 1.5 μm to about 3.5 μm, and all ranges and values in between whether expressly recited or not. The graphene-based planar sheets have a thickness of between about 0.4 nm to about 2.0 nm. An exemplary thickness is about 1.0 nm.

According to one aspect, the graphene-based planar sheets in the barrier layer are aligned substantially parallel to one another and having substantially contiguous overlapping planar sheet faces. According to one aspect, embodiments of the barrier layer lack a medium in which the graphene-based planar sheets are dispersed. According to certain embodiments, the graphene-based planar sheets are not dispersed throughout or otherwise fixed within a medium or matrix. Instead, according to aspects of the present disclosure, the graphene-based planar sheets are oriented substantially contiguous and overlapping such that at least a portion of the sheet faces of the graphene-based planar sheets are disposed adjacent sheet faces of one or more graphene-based planar sheets. According to one aspect, graphene-based planar sheets are tiled in an overlapping manner. According to one aspect, graphene-based planar sheets are tiled in an overlapping manner. According to one aspect, graphene-based planar sheets are tiled in an overlapping manner and are not overlapping identically as the graphene based planar sheets are not identical in structure insofar as they have irregular surface shapes and sizes. According to one aspect, graphene-based planar sheets in the barrier layer are ordered in an irregular manner with graphene based planar sheets overlapping one another.

According to one aspect, the barrier layer may include a single layer of graphene-based planar sheets. A single layer of graphene-based planar sheets has substantially contiguous overlapping planar sheet faces and includes an average thickness of between a single sheet thickness and a two-sheet thickness given the overlapping nature of the planar sheet faces. However, one of skill in the art will understand that since the barrier layers are formed from individual graphene-based planar sheets being tiled, individual layers may not be easily distinguishable. Instead, one of skill may determine the number of layers by measuring the thickness of the total barrier layer and dividing by the interlayer spacing to result in an average number of layers for a given barrier layer thickness. The interlayer spacing is usually understood as being the distance between nuclear planes. For unmodified graphene, the interlayer spacing is about 0.34 nm which, without wishing to be bound by scientific theory, represents the distance between nuclear planes where electron clouds of the planes are touching. As the spacing between planar sheets exceeds 0.34 nm because of modifications to the planar sheets with functional groups, the difference represents space into which free molecules may migrate. As the interlayer spacing increases, the space within which free molecules may migrate or be present increases thereby allowing molecules of varying sizes to migrate within the interlayer spacing. The larger the interlayer spacing, the larger the molecule that may be present within or migrating within the interlayer spacing. According to one aspect, the barrier layer includes between about 1 and about 50 layers of graphene-based planar sheets, between about 5 and about 40 layers of graphene-based planar sheets, between about 10 and about 30 layers of graphene-based planar sheets and all ranges and values in between whether expressly recited or not.

According to one aspect, the graphene-based planar sheets of the barrier layer have an interlayer spacing of between about 0.34 nm and about 2.0 nm or between about 0.4 nm and about 1.5 nm. According to one aspect, an interlayer spacing may be used to determine the average number of individual layers of graphene-based planar sheets in a barrier layer of a particular thickness. According to one aspect, the graphene-based planar sheets are crosslinked with a crosslinker. According to one aspect, the graphene-based planar sheets are crosslinked with one or more different crosslinkers. Suitable crosslinkers include short length crosslinkers. Short length crosslinkers have a molecular length of no more than 3 nm. Suitable crosslinkers include those readily known to those of skill in the art useful for crosslinking the functional groups which may be present on the graphene-based planar sheets. Exemplary crosslinkers include dihydrazides, diazides, polyamines such as triethylenetetraamine, polyamides, epoxides, and the like and other small molecules with chemically reactive groups on opposite ends of the molecule sufficient to react with two different graphene-based planar sheets. Suitable crosslinkers can be added to the liquid formulation including the graphene-based planar sheets. The liquid formulation can then be placed on the surface of a substrate and dried. The crosslinkers can react with the functional groups on the graphene-based planar sheets using methods and conditions known to those of skill in the art. Such crosslinking can be achieved simply by reacting the crosslinker with the functional groups. Heat and light can be used as energy sources to effect reaction of the crosslinkers with the functional groups. According to one aspect, low molecular weight crosslinkers are used to minimize the interlayer spacing between graphene-based planar sheets. According to one aspect, the interlayer spacing may be between about 0.4 nm and about 2.0 nm.

One method for crosslinking graphene oxide, such as in graphene oxide films, to improve stability and mechanical toughness is to use native epoxide groups present on graphene oxide as sites for cross-linking by externally added cross-linking agents based on epoxy adhesive chemistry. Accordingly, the functional group described about which is present on graphene oxide which can be used to react with a crosslinker as described herein is an epoxide. According to certain aspects, crosslinking is accomplished with a crosslinker reacting with at least an epoxide group from a first graphene oxide sheet or flake and an epoxide from a second graphene oxide sheet or flake, thereby interconnecting the first graphene oxide flake to the second graphene oxide flake. According to this aspect, the strength of crosslinking between a first graphene oxide sheet or flake and a second graphene oxide sheet or flake is determined in part by the relative number of epoxide groups on each graphene oxide sheet or flake that are crosslinked. Accordingly, exemplary graphene oxide sheets or flakes have a density of epoxide groups sufficient to provide effective crosslinking between graphene oxide sheets. The population of epoxide groups on graphene oxide can vary with the method used to make the graphene oxide. According to one aspect, graphene oxide has an epoxide-oxygen to carbon atom ratio of at least about 0.005, or about 1 epoxide group for every about 200 carbon atoms. This corresponds to about 0.2 milli-mole of epoxide groups per gram of graphene oxide. According to one aspect, graphene oxide has an epoxide-oxygen to carbon atom ratio of at least about 0.05, or about 1 epoxide group for every about 20 carbon atoms. This corresponds to about 2.0 milli-mole of epoxide groups per gram of graphene oxide. According to one aspect, graphene oxide has an epoxide-oxygen to carbon atom ratio of at least about 0.25, or about 1 epoxide group for every about 4 carbon atoms. It is to be understood that not all epoxide groups present on graphene oxide are required to be crosslinked by crosslinkers in order to produce graphene oxide that is effectively crosslinked. However, the more epoxide groups available for crosslinking, the greater the ability of the graphene oxide to be crosslinked. Also, the more epoxide groups that are crosslinked, the stronger the crosslinking between graphene oxide sheets or flakes. According to one aspect, epoxide groups present on graphene oxide may have a shelf life to the extent that epoxide groups are unstable and react with hydrogen atoms, for example, to form hydroxyl groups which may be less effective as functional groups for crosslinking. A source of hydrogen atoms may be chemisorbed hydrogen atoms that is part of the graphene oxide layer. Other sources of hydrogen atoms may be readily envisioned by those of skill in the art based on the present disclosure. The number of epoxide groups on graphene oxide may decrease over time thereby lowering or decreasing the ability of graphene oxide to be effectively crosslinked. According to this aspect, a minimum number of epoxy groups is advantageous for effective crosslinking. According to a similar aspect, methods of the present invention use active graphene oxide which is understood herein to be graphene oxide that has a minimum number of epoxide groups available for crosslinking. Active graphene oxide may be graphene oxide that is prepared shortly before use to minimize loss of epoxide groups through destabilizing reactions and to thereby maximize the number of epoxide groups available for crosslinking.

According to one aspect, barrier layers according to the present disclosure have an area density of graphene-based planar sheets in milligrams per square meter of barrier layer of between about 20 mg/m² and about 50 mg/m².

According to one aspect, a liquid including graphene-based planar sheets can be dried to form a barrier layer at an elevated temperature of above about 35° C., above about 40° C., above about 45° C., above about 50° C., above about 55° C., above about 65° C., above about 75° C., above about 85° C., above about 95° C., above about 100° C., above about 125° C., above about 150° C., above about 175° C., above about 200° C. According to one aspect, the drying temperature may depend on the ability of the substrate to remain unaltered by the temperature. According to one aspect, the liquid including the graphene-based planar sheets is dried under vacuum. According to one aspect, the liquid including the graphene-based planar sheets is dried at an elevated temperature of above about 35° C., above about 40° C., above about 45° C., above about 50° C., or above about 55° C., above about 65° C., above about 75° C., above about 85° C., above about 95° C., above about 100° C., above about 125° C., above about 150° C., above about 175° C., above about 200° C. and under vacuum. According to this aspect, the interlayer distance is minimized to the extent that interlayer liquid or interlayer water is removed. According to this aspect, the interlayer distance is minimized to prevent migration of molecules into and through the interlayer space.

According to one aspect, graphene-based films or layers, such as graphene-oxide layers or films may be thermally or chemically reduced to increase stability in aqueous media. Thermal reduction involves heating to a temperature above about 150° C. or as high as the substrate will allow before becoming damaged. Chemical reduction may be accomplished by treating the graphene-based films or layers, such as graphene-oxide layers or films, with one or more reducing agents either as vapors or solutions than include hydrazine, ascorbic acid, borohydride, citric acid, glutathione or other thiol-containing molecules. According to this aspect, the barrier layers of the present disclosure may include reduced graphene-based planar sheets.

According to one aspect, the barrier layers of the present disclosure have substantially no interstitial fluid. According to one aspect, the barrier layers of the present disclosure have substantially no interstitial water. According to this aspect, the graphene-based planar sheets have substantially no unbound small molecules therebetween. According to this aspect, the graphene-based planar sheets have substantially contiguous planar sheet faces to the extent that there are substantially no unbound small molecules therebetween.

Embodiments of the present disclosure are directed to a substrate having a graphene-based layer described herein on the surface of the substrate. The graphene-based layer inhibits movement of small molecules from one side of the graphene-based layer to the other. Accordingly, the substrate with the graphene-based layer thereon may be used as a barrier to the transport of small molecules. According to certain embodiments, application of the graphene-based layer to a substrate improves the substrate's ability to be a barrier to small molecules. According to certain embodiments, application of the graphene-based layer to a substrate contains small molecules to within the substrate that would otherwise migrate out of the substrate. According to one aspect, a barrier article is provided that includes a substrate and a continuous graphene-based layer adhered to the surface of the substrate, wherein the continuous graphene-based layer is substantially impermeable to transmission of small molecules through the graphene-based layer.

Exemplary substrates within the scope of the present disclosure may be rigid or flexible. Exemplary substrates within the scope of the present disclosure include polymer sheets and textiles. Exemplary polymers and monomers used to make polymer sheets include polyethylene, polypropylene, polyethylene terephthalate, polyvinyl chloride, polyvinilydine chloride, acrylic, acetate, neoprene, silicone rubber and the like. Polymer sheets are known to those of skill in the art. Exemplary textiles include cotton, wool, polyester, nylon, Teflon, Gortex, glass, fiberglass and the like or combinations thereof. Textiles and textile materials are known to those of skill in the art.

According to one aspect, exemplary substrates include rigid substrates such as wood, metal, polymers, ceramics, and the like, including particle board, fiber board, hardwood, softwood, tiles, masonry, concrete and the like. According to this aspect, certain substrates may include small molecules prone to migrate out of the substrate. According to one aspect, the substrate is provided with a continuous graphene-based layer to contain small molecules within the substrate that would ordinarily migrate out of the substrate. According to one aspect, the substrate includes a hazardous material, such as lead paint, and the substrate is provided with a continuous graphene-based layer to contain the hazardous material or otherwise seal the hazardous material from the environment. Exemplary substrates include building or construction materials such as wood, manufactured wood products, particle board, fiber board, plywood, drywall, metal support structures, concrete, masonry and the like. For example, common manufactured wood products such as particle board or fiber board utilize formaldehyde in an adhesive to bind particles or fibers together. Formaldehyde is gradually released from the manufactured wood product. According to one aspect, such manufactured wood products may be provided with a continuous graphene-based layer to contain the formaldehyde or other small molecules within the substrate. Similarly, metal structures may be provided with a graphene-based layer to prevent water molecules from contacting the metal structure thereby reducing oxidation or metal corrosion. Accordingly, a method is provided for reducing metal corrosion by applying a graphene-based layer to a metal substrate, thereby reducing corrosion caused by water, such as water present in the atmosphere as humidity. In addition, certain metals may release toxicants such as chromium or lead. Metal structures may be provided with a graphene-based layer to prevent small molecules, such as toxicants like chromium or lead from migrating from the metal structure. Accordingly, a method is provided for containing small molecule toxicants within a metal substrate by applying a graphene-based layer to the metal substrate, thereby preventing migration of the small molecule toxicants out of the metal substrate.

According to certain aspects, methods are provided for reducing or preventing growth of microorganisms, such as mold or bacteria, on a substrate by providing the substrate with a graphene-based layer. According to this aspect, the graphene-based layer separates microorganisms from the surface of the substrate thereby preventing the microorganisms from using the substrate as a food source. Alternatively, in the case of aerobic microorganisms which may be on the surface of the substrate, a graphene-based layer is provided over the aerobic microorganism on the surface of the substrate thereby reducing a nutrient, such as oxygen, required by the aerobic microorganism to grow. According to this aspect, the environment of aerobic microorganism on the surface of the substrate is rendered hypoxic and the proliferation of the aerobic microorganism is reduced or eliminated or the aerobic microorganism is killed. An exemplary microorganism is Legionella bacteria which is an aerobic bacteria. Other microorganism whether aerobic or anaerobic are known to those of skill in the art.

According to one aspect, the substrate may be a medical device or implant fashioned out of metal, polymer, ceramic or the like. Medical devices or implants may be provided with a continuous or substantially continuous graphene-based layer such that small molecules within the medical device or implant which would ordinarily migrate out of the medical device or implant, or leach from its surface, may be contained within the medical device or implant. Exemplary medical devices or implants include artificial hips, knees and other joints, bone grafts, electrode arrays and associated circuitry for neural stimulation and recording, catheters, delivery pumps, pacemakers and the like. Additional medical devices or implants are known to those of skill in the art.

According to one aspect, the substrate may be a packaging or container or liner for a container that includes consumables or ingestibles such as foods, beverages, medicines, pharmaceuticals, and any other substances intended to be included in the body. According to this aspect, the packaging or container or liner for a container is provided with a continuous or substantially continuous graphene-based layer such that the continuous or substantially continuous graphene-based layer is provided between the consumable or ingestible and small molecules that may be present in packaging that are intended to be separate from the consumable or ingestible and that may be leachable or extractable into the consumable or ingestible. In this manner, the graphene-based layer prevents or inhibits migration of the small molecules into the consumable or ingestible. Accordingly, aspects of the present disclosure provide barriers to leachables or extractables in food, beverage, medicine or pharmaceutical packages or containers.

According to one aspect, the substrate may be a packaging or container or liner for a container that includes a small molecule toxicant. Exemplary packaging or containers include “bag-in-a-box-type” containers intended to include fluids. Such packaging or containers formed from polymers may contain residual monomers, plasticizers, degradation products or other small molecules that can diffuse out and into the product contained within the packaging or container. Also, inks and adhesives used with the packaging may diffuse through the packaging and into the product within the packaging. According to this aspect, the packaging or container or liner for a container is provided with a continuous or substantially continuous graphene-based layer such that the continuous or substantially continuous graphene-based layer separates the small molecule toxicant that may be contained within the packaging or container or liner for the container from the product within the packaging or container. In this manner, the graphene-based layer prevents or inhibits migration of the small molecule toxicant from the packaging or container or liner for the container and into the product. As an example, the interior of a plastic container having small molecule toxicants may be provided with a continuous or substantially continuous graphene-based layer to separate the small molecule toxicants from the contents of the container. An additional substrate layer may also be placed within the interior of the plastic container to sandwich the continuous or substantially continuous graphene-based layer. In this manner, the continuous or substantially continuous graphene-based layer is protected from the contents of the container with a substrate that may contain no small molecule toxicants or fewer small molecule toxicants that the packaging or container itself. In a similar manner packaging or containers are provided which are intended to contain small molecule toxicants. Such a packaging or container includes a continuous or substantially continuous graphene-based layer as discussed herein. According to this aspect, the continuous or substantially continuous graphene-based layer inhibits or prevents migration of the small molecule toxicants through the packaging or container.

According to one aspect, the substrates have dimensions sufficient to contain small molecules within a particular area or separate small molecules from a particular environment. Substrates may have a surface area on the order of square inches, square, feet, square yards, or square miles.

According to one aspect, a graphene-based layer described herein may be between two substrates of the same or different material. In this manner, the graphene-based layer may be sandwiched between two substrates.

According to one aspect, the substrate may be surface treated to improve adhesion of the graphene-based layer to the substrate. According to one aspect, the surface of the substrate is rendered hydrophilic such that aqueous formulations of the graphene-based planar sheets evenly spread over the surface of the substrate. According to this aspect, the surface treatment provides for uniform deposition of the graphene-based planar sheets allowing for a uniform barrier layer at low mass loadings. According to one aspect, the surface of the substrate is treated with a treatment medium that renders the substrate surface more cationic. A cationic substrate surface more readily disperses and binds to anionic graphene-based planar sheets. Graphene-based planar sheets may be rendered anionic due to the functional groups thereon. Suitable treatment media include chemical media such as cationic compounds or surfactants. Exemplary treatment media include surfactants or polymers including amine groups or quaternary nitrogen groups such as CTAB or polyallylamine. A substrate surface may also be treated with a non-chemical treatment medium such as electrical or corona discharge methods. Methods of surface treating substrate surfaces to render them more cationic are known to those of skill in the art.

Exemplary barrier articles include, landfill liners, landfill caps, vertical subsurface containment barriers, subsurface permeable reactive barriers, vapor intrusion barriers, such as radon barriers, tarp barriers for containment of soil fumigants, Resource Conservation and Recovery Act (RCRA) caps on Brownfield sites and other environmental barriers which are intended to contain small molecule toxicants.

Exemplary barriers include hazardous material suits, biochemical suits or protective suits in general where a substrate includes a continuous or substantially continuous graphene-based layer and the material is fashioned into a wearable enclosure for an individual. According to this aspect, the wearable enclosure separates the individual from small molecule toxicants in the environment. Wearable enclosures, such as hazardous material suits, are well known to those of skill in the art.

Small molecules intended to be either contained or separated by the graphene-based layers and barrier articles of the present disclosure include volatile organic compounds or semi-volatile organic compounds, such as those found on environmental contamination sites including benzene, toluene, xylenes, polyaromatic compounds, solvents including perchloroethylene, trichloroethylene, methylenechloride, methyl tertiary butyl ether, and mycotoxins. Small molecules also include leachables or extractables found in packaging materials such as phthalates, bisphenol A, inks containing benzophenone or 1-benzoylcyclohexanol or 2-hydroxy-2-methylpropiophenone, 2-methylpentane, 3-methylpentane, hexane, methylcyclopentane, cyclohexane, BHT and compounds used in polymer, ink, and adhesive formulations. Small molecules include volatile organic compounds or semi-volatile organic compounds used to manufacture building materials.

Exemplary small molecules include mercury, mercury vapor, chromium, lead, oxygen, formaldehyde, aromatic hydrocarbons, trichloroethylene, perchloroethylene, soil fumagants, radon, chemical and biological agents used in military applications, corrosive vapors such as HCl, HF, HNO₃ or other acids or bases and toxic or odor-generating vapors from contaminated sites or landfills.

In general, the term small molecule may refer to any molecule that has a size larger than the interlayer spacing of graphene-based planar sheets of the barrier layer. If the molecule has a size larger than the interlayer spacing of the graphene-based planar sheets of the barrier layer, then the barrier layer will be a barrier to the molecule. Stated differently, if the interlayer spacing of the graphene-based planar sheets of the barrier layer is smaller than a particular molecule, then the barrier layer will be a barrier to the particular molecule. The smaller the interlayer spacing of the barrier layer, the greater the capability of the barrier layer to act as a barrier to the migration of molecules through the barrier layer.

According to an additional aspect, a method of making a barrier article is provided including the steps of contacting a liquid solution of graphene-based sheets to a substrate, and drying the liquid solution to produce a continuous graphene-based layer adhered to the surface of the substrate, wherein the continuous graphene-based layer is substantially impermeable to transmission of small molecules through the graphene-based layer. In this manner, a method of rendering a substrate impermeable to small molecules is provided that includes the steps of contacting a liquid solution of graphene-based sheets to the substrate, and drying the liquid solution to produce a continuous graphene-based layer adhered to the surface of the substrate, wherein the continuous graphene-based layer is substantially impermeable to transmission of small molecules through the graphene-based layer.

According to certain aspects, the liquid solution of graphene-based sheets is an aqueous formulation. According to certain aspects, the graphene-based sheets in a water phase are deposited onto the surface of a substrate, such as a polymer film to produce ultrathin coatings of the graphene-base sheets having a thickness of between about 5 nm to about 100 nm. The coating of the graphene-based sheets enhances the barrier properties of the substrate to which it is applied.

Methods of applying liquid formulations to the surface of a substrate useful herein are well known to those of skill in the art and include, spin casting methods, drop casting methods, spray casting methods, dip casting methods, doctor blading methods, large scale roll-to-roll processing and the like.

The barrier articles described herein may be used to contain small molecules on one side of a barrier article. Accordingly a method is provided to contain small molecules on one side of a barrier article including the steps of placing the barrier article between the small molecules and an environment wherein the barrier article inhibits movement of the small molecules into the environment, and wherein the barrier article includes a substrate and a continuous graphene-based layer adhered to the surface of the substrate, wherein the continuous graphene-based layer is substantially impermeable to transmission of the small molecules through the graphene-based layer.

According to one aspect, a method of sealing openings on a substrate is provided which includes the steps of contacting a liquid solution of graphene-based sheets to the substrate wherein the graphene-based sheets collect at least over an opening on the substrate, and drying the liquid solution to produce a continuous graphene-based layer substantially sealing the opening to transmission of small molecules.

It is to be understood that the embodiments of the present invention which have been described are merely illustrative of some of the applications of the principles of the present invention. Numerous modifications may be made by those skilled in the art based upon the teachings presented herein without departing from the true spirit and scope of the invention. The contents of all references, patents and published patent applications cited throughout this application are hereby incorporated by reference in their entirety for all purposes.

The following examples are set forth as being representative of the present invention. These examples are not to be construed as limiting the scope of the invention as these and other equivalent embodiments will be apparent in view of the present disclosure, figures, and accompanying claims.

### EXAMPLES

The following examples are specific embodiments of the present disclosure but are not intended to limit it.

### Example I

### Preparation of Graphene Oxide

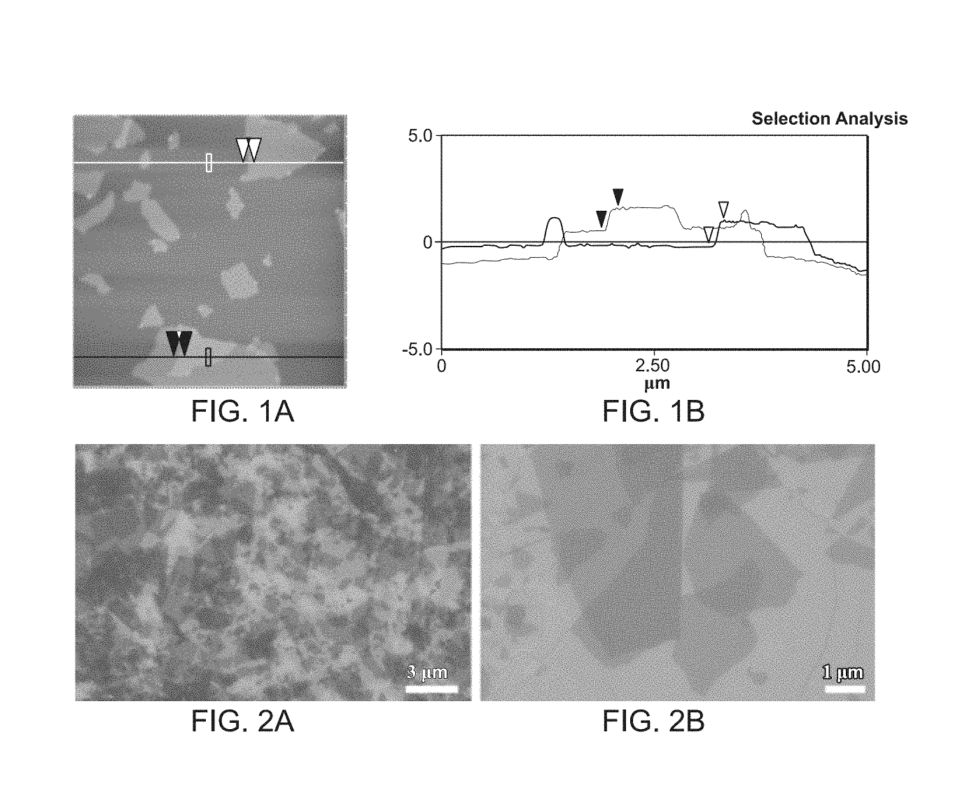

Graphene oxide (GO) was prepared by a modified Hummers method with preoxidation treatment as described in Hummers, W. S. and R. E. Offeman (1958) “Preparation of Graphitic Oxide,” Journal of the American Chemical Society 80(6): 1339-1339 and purified by a two-step acid-acetone wash for suppressing gelation and removing the salt byproducts as described in Kim, F., J. Y. Luo, R. Cruz-Silva, L. J. Cote, K. Sohn and J. X. Huang (2010) “Self-Propagating Domino-like Reactions in Oxidized Graphite,” Advanced Functional Materials 20(17): 2867-2873. The graphene oxide sheets were deposited on a mica surface and analyzed using an atomic force microscope. FIG. 1A is an image showing graphene oxide sheets or flakes on the mica surface. The graphene oxide sheets have an irregular shape. A section analysis shown in FIG. 1B shows a 1.1 nm step between sheets indicating that the majority of the sheets or flakes are graphene oxide monolayers.

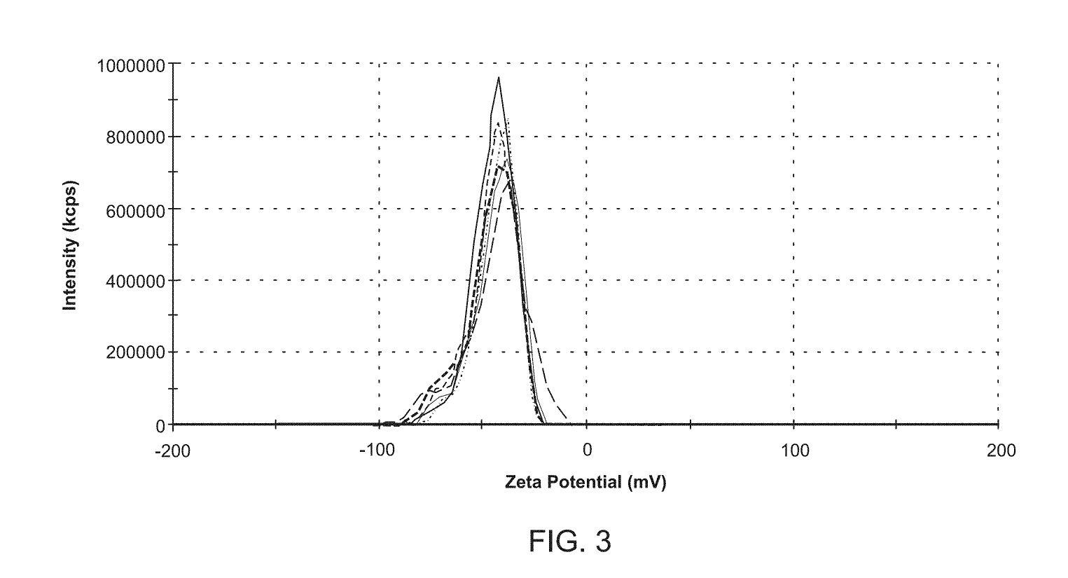

The lateral dimensions of the graphene oxide sheets were analyzed. Graphene oxide sheets were deposited on a silicon substrate by drop casting a dilute graphene oxide suspension. The samples were heated at 700° C. under N₂ for 5 min in order to reduce the graphene oxide sheets, and enhance the conductivity so as to obtain SEM images. FIG. 2A is an image of graphene oxide sheets showing a scale of 3 μm. FIG. 2B13 is an image of graphene oxide sheets showing a scale of 1 μm. As shown in FIG. 2A and FIG. 2B, lateral sizes of graphene oxide sheets range from about 0.3 μm to about 3 μm.

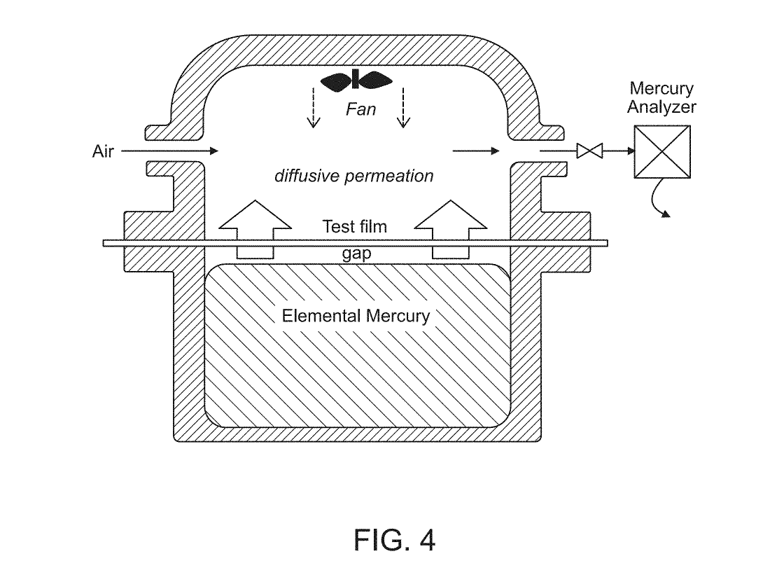

The dispersibility of graphene oxide sheets in water was analyzed using dynamic light scattering to characterize surface charge of graphene oxide sheets in aqueous phase. FIG. 3 is a graph of intensity versus zeta potential. The zeta potential of GO sheets in water is approximately −50 mV, which is consistent with their stable dispersion in water.

### Example II

### Preparation of a Substrate with a Graphene Oxide Layer

Uniform graphene oxide films or layers were prepared on a polymer substrate using drop casting as follows. Polyethylene film was obtained from McMaster-Carr. The polyethylene film was surface treated with a cationic surfactant. Briefly, a circular polyethylene sheet with a diameter of 20 cm was cleaned with ethanol and nanopure water, and immersed in a shallow pool of 173 ppm cetyl trimethylammonium bromide (CTAB) for 10 minutes to increase surface hydrophilicity and impart positive charge. The sheet was dried at 70° C. for 60 minutes and stretched over a 20 cm glass plate and secured with adhesive tape to eliminate wrinkles and creases. The graphene oxide suspension was diluted (typically 0.05-0.5 mg/mL), and 25 mL of the dilution was drop cast in the center of the polyethylene sheet. The sample, consisting of glass plate, polyethylene sheet, CTAB layer, and graphene oxide drop, was dried in air or placed in the drying oven at 70° C. for 48 hours. The polyethylene sheet with the graphene oxide layer was then removed from the glass plate and its mercury vapor permeability was tested.

### Example III

### Vapor Permeability Analysis of a Substrate with a Graphene Oxide Layer

Elemental mercury has been reported to pass readily through common polymers used in fluorescent lamp disposal and recycling, and was selected as a model permeating vapor toxicant for this Example. Mercury permeability constants for various polymer substrates were determined to help guide selection of containment materials for mercury containing products and wastes.

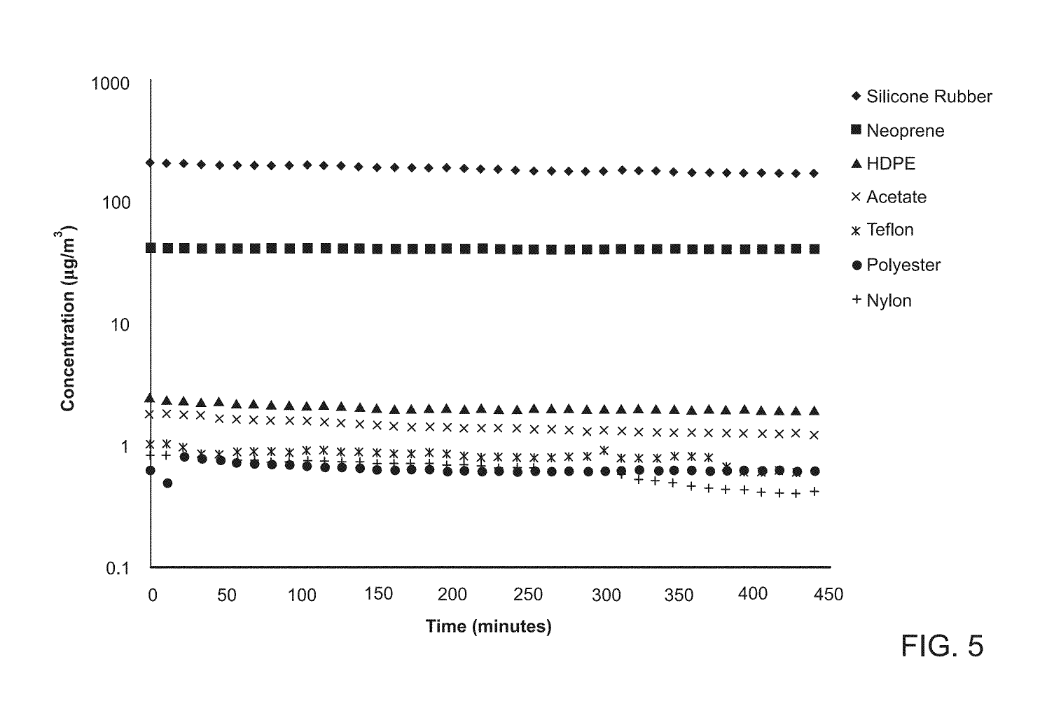

Permeability of various polymer sheets and the polyethylene sheet with the graphene oxide layer of Example II to mercury vapor was tested using the glass mercury diffusion cell apparatus depicted in FIG. 4.

The glass mercury diffusion cell uses Viton O-rings to seal a polymer film or polymer/graphene oxide film over a standing pool of elemental mercury of 50 mm depth and 74 mm diameter. To reduce gas-phase transport resistance, the membrane was positioned only 2 mm above the pool surface giving a mass transfer coefficient of order D/δ (stagnant gas limit), which represents less than 5% of the resistance of the polymer film. Downstream of the membrane, a miniature electric fan forces convective flow onto the test surface which reduces gas-phase transport resistance to small values. The mercury concentration in the exit stream (200 cc/min) was determined by a semi-continuous gold-trap atomic fluorescence mercury vapor analyzer (Sir Galahad, PSAnalytical) and the mercury molar flow converted to permeation flux. The analysis stream induced an equivalent in-flow of room air (200 cc/min) from a side pore in the upper half of the cell, which also serves as a feed for the electrical wiring. To avoid mercury contamination above the film, the cap was kept separate from the pool between tests and was purged with compressed air for several minutes between each test. A thick impermeable control film of polyethylene terephthalate was inserted between each test until baseline concentrations of exit Hg reached suitably low baseline values.

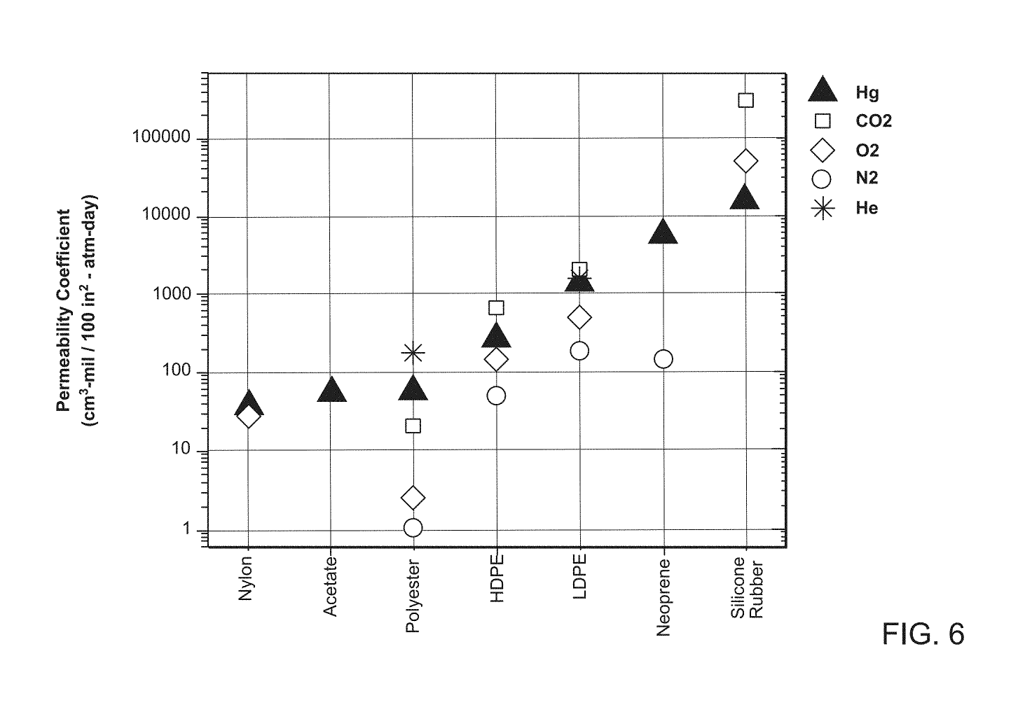

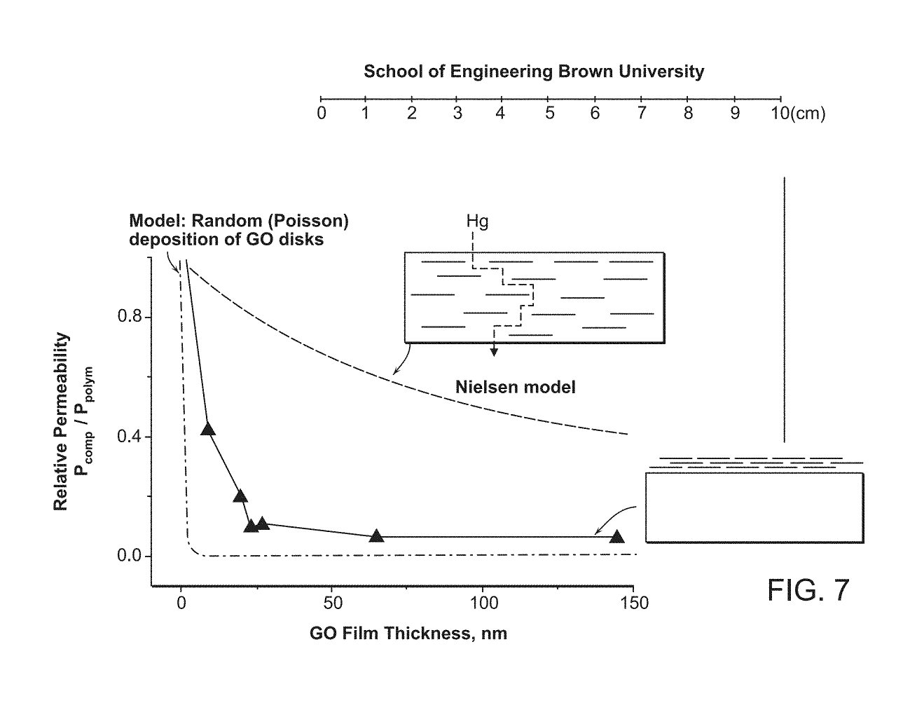

For sheets, the permeation rate R (mol/s) is given by: R=APΔC, where A is the membrane area and P is the permeability, P=DH/δ, where D is the diffusion coefficient of Hg in the polymer, δ the film thickness, and H the partition coefficient of Hg in the two phases at equilibrium (C^{polymer}/C^{vapor}). In these experiments the pre-membrane concentration is saturated Hg vapor (18,000 μg/m³ at 23° C.), (see Huber, M. L.; Laesecke, A.; Friend, D. G., Correlation for the vapor pressure of mercury, Ind. Eng. Chem. Res. 2006, 45, (21), 7351-7361) and the post-membrane concentration is approximately equal to the measured steady state exit concentration due to active stirring in the head space. Example raw data is shown in FIG. 5 which depicts steady state concentration of mercury vapor above the polymer membranes in the cell. The permeability calculations are based on the final steady state values. For highly permeable materials, membranes were stacked to increase resistance and in all cases, the permeability coefficient (DH) was reported, which unlike the permeability itself (DH/δ) is a material property independent of sheet thickness. FIG. 6 shows that common polymers exhibit a wide range of permeability coefficients for vapor-phase Hg (atomic diameter: 0.3 nm) and that the values are of the same order of magnitude as values for small gases O₂ (0.35 nm), N₂ (0.37 nm) or CO₂ (0.4 nm) (see Hirschfelder, J. O.; Bird, R. B.; Curtiss, C. F., Molecular theory of gases and liquids Wiley: New York, 1954.) Nylon, acetate, and polyester show the lowest permeability coefficients, followed by high-density polyethylene at ˜5× higher permeability, and the elastomers (neoprene, silicone).

The conventional approach to barrier enhancement is to add the low-permeability component as filler uniformly distributed in the polymer matrix. Mineral flakes are a common filler, (see (26) Cussler, E. L.; Hughes, S. E.; Ward, W. J.; Aris, R., Barrier Membranes, J. Membrane Sci. 1988, 38, (2), 161-174; Eitzman, D. M.; Melkote, R. R.; Cussler, E. L., Barrier membranes with tipped impermeable flakes, Aiche. J. 1996, 42, (1), 2-9; Moggridge, G. D.; Lape, N. K.; Yang, C. F.; Cussler, E. L., Barrier films using flakes and reactive additives, Prog. Org. Coat 2003, 46, (4), 231-240; Lape, N. K.; Nuxoll, E. E.; Cussler, E. L., Polydisperse flakes in barrier films, J. Membrane Sci. 2004, 236, (1), 29-37; Yang, C. F.; Smyrl, W. H.; Cussler, E. L., Flake alignment in composite coatings, J. Membrane Sci. 2004, 231, (1-2), 1-12.) They suppress permeation better than spheres or cylinders at equal volume percentage (see DeRocher, J. P.; Gettelfinger, B. T.; Wang, J. S.; Nuxoll, E. E.; Cussler, E. L., Barrier membranes with different sizes of aligned flakes, J. Membrane Sci. 2005, 254, (1-2), 21-30.) The primary mechanism of barrier enhancement is an increase of the diffusive path length described by Eq. (1), the simple Nielsen model (see Nielsen, L. E., Models for the Permeability of Filled Polymer Systems. Journal of Macromolecular Science: Part A—Chemistry 1967, 1, (5), 929-942.)

$$\frac{P}{{P}_{m}} = \frac{1 - φ}{1 + 0.5 α φ} \qquad ( 1 )$$

Here P is the permeability of the composite; Pₘ is the permeability of the matrix material; ϕ is the volume fraction of the flake fillers; α is the aspect ratio (lateral size/thickness). The performance of fillers in the imbedded (Nielsen) configuration is limited because it does not necessarily alter the diffusion coefficient in the polymer phase, but only increases path length.

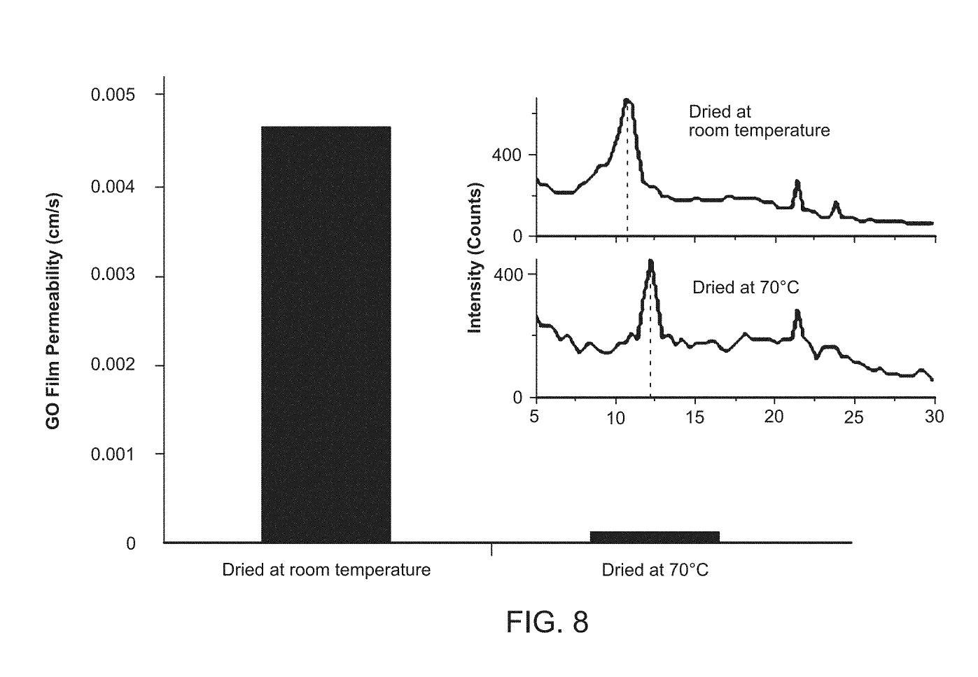

According to one aspect of the present disclosure, greater barrier enhancement is achieved by collapsing the graphene oxide flakes into a film that also restricts horizontal migration which is depicted in FIG. 7. There are several ways to make GO films. See, Compton, O. C.; Kim, S.; Pierre, C.; Torkelson, J. M.; Nguyen, S. T., Crumpled Graphene Nanosheets as Highly Effective Barrier Property Enhancers, Adv. Mater. 2010, 22, (42), 4759-+; Kim, H.; Miura, Y.; Macosko, C. W., Graphene/Polyurethane Nanocomposites for Improved Gas Barrier and Electrical Conductivity, Chem. Mater. 2010, 22, (11), 3441-3450; Kim, H. M.; Lee, J. K.; Lee, H. S., Transparent and high gas barrier films based on poly(vinyl alcohol)/graphene oxide composites, Thin Solid Films 2011, 519, (22), 7766-7771; Stankovich, S.; Dikin, D. A.; Piner, R. D.; Kohlhaas, K. A.; Kleinhammes, A.; Jia, Y.; Wu, Y.; Nguyen, S. T.; Ruoff, R. S., Synthesis of graphene-based nanosheets via chemical reduction of exfoliated graphite oxide, Carbon 2007, 45, (7), 1558-1565; Eda, G.; Fanchini, G.; Chhowalla, M., Large-area ultrathin films of reduced graphene oxide as a transparent and flexible electronic material, Nat. Nanotechnol. 2008, 3, (5), 270-274; Eda, G.; Chhowalla, M., Chemically Derived Graphene Oxide: Towards Large-Area Thin-Film Electronics and Optoelectronics, Adv. Mater. 2010, 22, (22), 2392-2415; Chen, C. M.; Yang, Q. H.; Yang, Y. G.; Lv, W.; Wen, Y. F.; Hou, P. X.; Wang, M. Z.; Cheng, H. M., Self-Assembled Free-Standing Graphite Oxide Membrane, Adv. Mater. 2009, 21, (29), 3007; Guo, F.; Kim, F.; Han, T. H.; Shenoy, V. B.; Huang, J. X.; Hurt, R. H., Hydration-Responsive Folding and Unfolding in Graphene Oxide Liquid Crystal Phases, ACS Nano 2011, 5, (10), 8019-8025; Stankovich, S.; Dikin, D. A.; Dommett, G. H. B.; Kohlhaas, K. M.; Zimney, E. J.; Stach, E. A.; Piner, R. D.; Nguyen, S. T.; Ruoff, R. S., Graphene-based composite materials, Nature 2006, 442, (7100), 282-286; Li, D.; Muller, M. B.; Gilje, S.; Kaner, R. B.; Wallace, G. G., Processable aqueous dispersions of graphene nanosheets, Nat. Nanotechnol. 2008, 3, (2), 101-105; Yamaguchi, H.; Eda, G.; Mattevi, C.; Kim, H.; Chhowalla, M., Highly Uniform 300 mm Wafer-Scale Deposition of Single and Multilayered Chemically Derived Graphene Thin Films, ACS Nano 2010, 4, (1), 524-528; Dikin, D. A.; Stankovich, S.; Zimney, E. J.; Piner, R. D.; Dommett, G. H. B.; Evmenenko, G.; Nguyen, S. T.; Ruoff, R. S., Preparation and characterization of graphene oxide paper, Nature 2007, 448, (7152), 457-460; Lee, S. H.; Kim, H. W.; Hwang, J. O.; Lee, W. J.; Kwon, J.; Bielawski, C. W.; Ruoff, R. S.; Kim, S. O., Three-Dimensional Self-Assembly of Graphene Oxide Platelets into Mechanically Flexible Macroporous Carbon Films, Angew. Chem. Int. Edit. 2010, 49, (52), 10084-10088. According to one aspect, a grapheme oxide suspension was directly cast onto polymer membranes pretreated with the cationic surfactant CTAB to impart hydrophilicity and positive charge. The thickness of the films can be varied by GO concentration and liquid volume. The GO laminates are observed to be adherent and mechanically stable on the polyethylene surfaces even after hand folding. The polymers with GO nanofilms are noticably darker than the untreated polymers but still transparent as shown in FIG. 7.

FIG. 7 shows that the film configuration is indeed highly effective as a barrier enhancement. GO films of only 10 nm thickness can suppress Hg-vapor permeability by 60%, and 20 nm coatings can achieve˜90% reduction. The barrier suppression is much greater than that expected for ideal imbedding, as predicted by the Nielsen model (Eq.1) for horizontally aligned single-sheet flakes at the same GO/polymer mass loading (reference curve in FIG. 7). Many experimental studies with imbedded clay or graphene materials do not achieve the Nielsen limit due to non-uniform mixing or to misalignment, so the ability of these films to exceed the Nielsen limit is significant.

The film results can also be compared to a simple model in which thin disks randomly deposit on the polymer surface and cast diffusion shadows that inhibit transport into and through the film. In the limit of thin polymer films, this blockage is directly proportional to the fractional coverage, if the disks fall by an independent Poisson process that allows overlap (See (43) Jupp, D. L. B.; Strahler, A. H.; Woodcock, C. E., Autocorrelation and regularization in digital images. II. Simple image models. Geoscience and Remote Sensing, IEEE Transactions on 1989, 27, (3), 247-258.) In this case the inhibition is described in the formula below where P/Pₘ is the relative permeability, Q the proportion of uncovered area which equals to the relative permeability; λ the density of disk centers in counts per square areal unit; A is the disk area; n is the number of layers.

$$\frac{P}{{P}_{m}} \approx Q = {e}^{- λ A} = {e}^{- n} \qquad ( 2 )$$

### Example IV

### Effect of Heating on Permeability

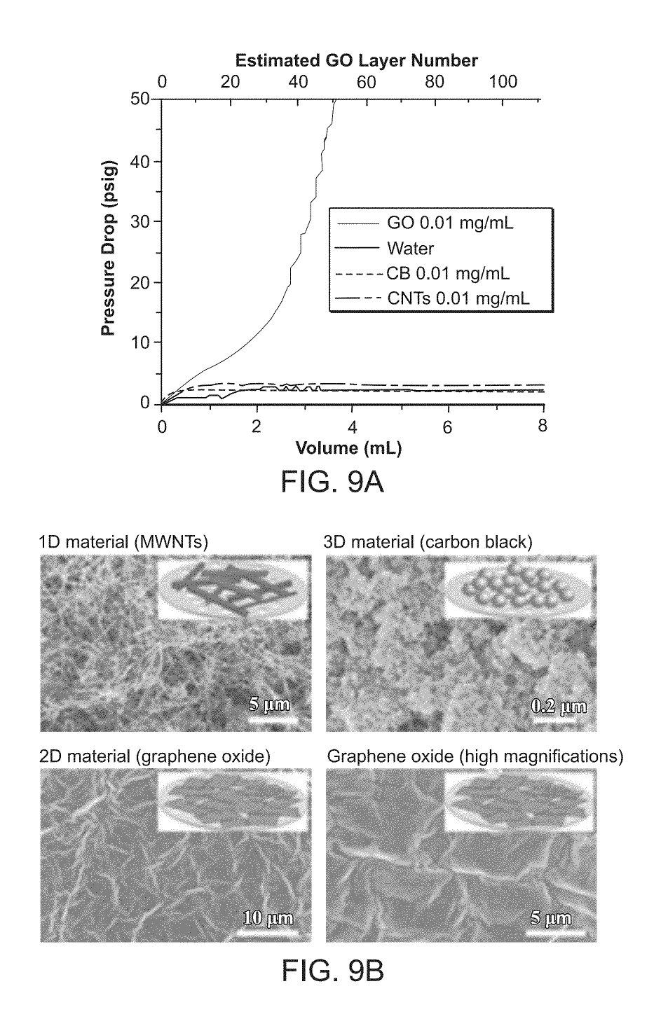

The mercury permeability of graphene oxide-coated polyester was found to be sensitive to drying conditions. FIG. 8 shows the permeability of films dried at room temperature at 15% relative humidity for 48 hours (left), and at approximately 70° C. with zero relative humidity for 48 hours (right). As demonstrated in FIG. 8, films dried at room temperature show significantly higher Hg-vapor permeabilities than films dried at 70° C. This effect is believed to be due to lateral diffusion of Hg through the expanded layer structure associated with interlayer water (See Nair, R. R.; Wu, H. A.; Jayaram, P. N.; Grigorieva, I. V.; Geim, A. K., Unimpeded Permeation of Water Through Helium-Leak-Tight Graphene-Based Membranes, Science 2012, 335, (6067), 442-444.)

X-ray diffraction analysis of the films showed that the high-temperature drying decreased interlayer spacing consistent with interstitial water removal. The X-ray diffraction (XRD) spectra in FIG. 8 show that these two drying conditions lead to interlayer spacings of 0.82 nm and 0.73 nm respectively. These GO films have an area density of 35 mg/m² and approximately 25 layers.

### Example V

### Graphene Oxide Sealants

Suspensions of graphene oxide, multi-walled aryl-sulfonated carbon nanotubes commercially available from Mitsui (having a nominal diameter of between about 20-100 nm and a length of about 15 μm), and aryl-sulfonated carbon black particles (Printex 90, primary particle diameter of about 14 nm,) were subjected to pressure-driven flow through syringe filters (Anotop 25: Whatman Ltd., pore size 20 nm, filtration area 4.78 cm²; or Nylon syringe filters: Cameo 17GN, pore size 220 nm, filtration area 1.0 cm²) using a syringe pump (Sage 361) at 1 mL/min. The hydraulic pressure drop was monitored over time by an upstream pressure sensor (USB output PX409, Omega).

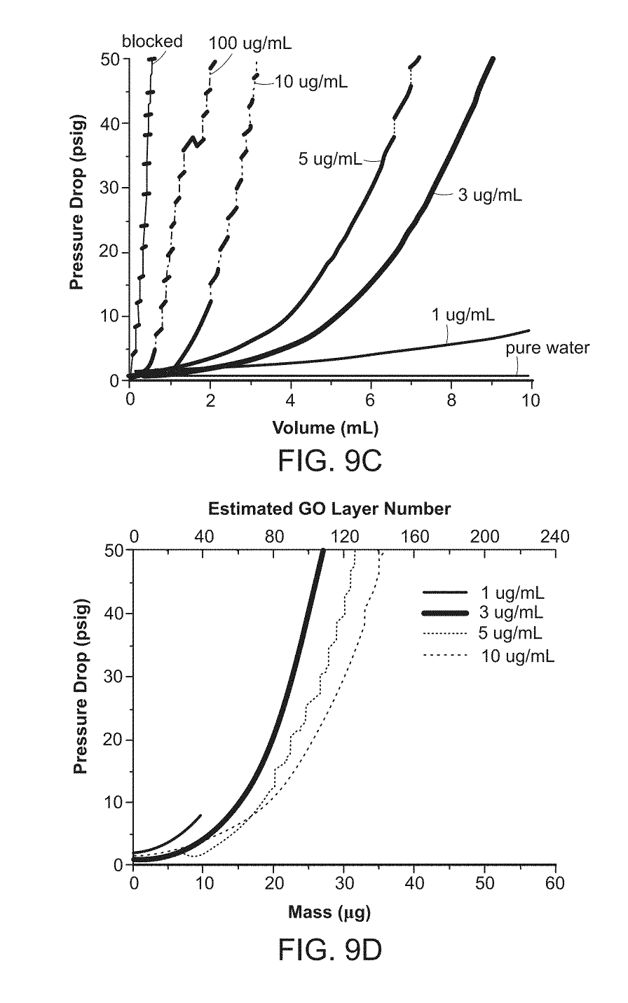

As shown in FIG. 9A, graphene oxide produces a diverging pressure drop after several ml of flow. As shown in FIG. 9B, graphene oxide forms a dense surface film with a micron-scale tiling or wrinkle pattern, while the carbon black and carbon nanotubes form porous deposits. The development of the sealant film was tracked at higher resolution by a set of time-resolved experiments using different graphene oxide concentrations as shown in FIG. 9C. FIG. 9D collapses that data set by renormalization using GO mass on X-axis calculated as V_{filtrate}×C_{GO}, which represents the total GO mass collected at time t. The total amount of graphene oxide deposited was directly proportional to sealant performance. Beyond 40 μg deposited or about 160 graphene oxide layers, the porous material is effectively sealed irrespective of the applied pressure. At a typical wet graphene oxide spacing of about 1 nm, the 50-layer stack in FIG. 9A represents a film of only 50 nm in thickness. Barrier materials to convective water flow are often characterized by the hydraulic conductivity, K, defined by ν=KΔP/δ_{film}. At 50 nm, K=5×10⁻¹³ m²/bar-sec, or with pressure expressed in equivalent water column height, K=5×10⁻¹² cm/s. At the end of the pressure experiment, ΔP is increasing rapidly, which suggests that K values will continue to decrease rapidly as deposition continues beyond the range accessible to the experiment.

### Example VI

### Stretchable Graphene-Based Barrier Layers

One aspect of the present disclosure is directed to stretchable graphene-based barrier layers and methods of making such stretchable graphene-based barrier layers. Stretchable graphene-based barrier layers may include one or more of graphene, graphene oxide or reduced graphene oxide as described herein. Stretchable graphene-based barrier layers may be continuous or substantially continuous. According to one aspect, a graphene-based barrier layer is created that can be stretched or elongated while still functioning as a barrier layer. According to one aspect, a graphene-based barrier layer is created that can be reversibly stretched or elongated while still functioning as a barrier layer. The graphene-based barrier layer is reversibly stretched or elongated insofar as the graphene-based barrier layer may be elongated or stretched from an original position and then may return to its original position when the force used to stretch or elongate the graphene-based barrier layer is relaxed. Such stretchable, for example, reversibly stretchable, graphene-based barrier layers have particular application on substrates that may be stretched or elongated from a first configuration or orientation to a second configuration or orientation and then, if desired, returned to the first configuration or orientation, during normal use of the substrate while maintaining the ability of the graphene-based barrier layer to prevent diffusion or migration of molecules through the graphene-based barrier layer, i.e. so as to provide protection from toxic molecules.

Stretchable substrates may be fashioned from or include one or more elastomeric materials, i.e. materials which can be stretched and the relaxed to recover their original shape or substantially recover their original shape. One of skill will readily be able to identify suitable stretchable or elastomeric materials based on the present disclosure. Exemplary stretchable or elastomeric materials include elastic polymers or rubbery materials. Exemplary stretchable or elastomeric materials include natural or synthetic polyisoprene, polybutadiene, chloroprene, polychloroprene, butyl rubber, styrene-butadiene rubber, latex rubber, nitrile rubber, ethylene propylene rubber, epichlorohydrin ruber, polyacrylic rubber, fluorosilicone rubber, fluoroelastomers, perfluoroelastomers, polyether block amides, chlorosulfonated polyethylene, ethylene-vinyl acetate and the like. Other stretchable or elastomeric materials will become apparent to those of skill in the art based on the present disclosure.

According to one aspect, an additional stretchable or elastomeric substrate layer may be used to sandwich the stretchable graphene-based layer. In this manner, the stretchable graphene-based layer is protected from the environment which may be desirable where the stretchable graphene-based layer may be abraded or wear through due to contact through use. Accordingly, sandwich or layered structures are provided where the stretchable graphene-based layer is an inner layer between two outer layers of substrate, such as a stretchable or elastomeric substrate as described herein. The substrate layers may be the same or different. The substrate layers may include the same materials or different materials. Accordingly, a laminate structure is provided where one or more stretchable graphene-based layers are sandwiched between two stretchable or elastomeric substrate layers. The layering may repeat such that a laminate structure includes a plurality of stretchable graphene-based layers and a plurality of substrate layers. According to this aspect, the laminate structure may have a substructure including two substrate layers on either side of a stretchable graphene-based layer, for example a layered structure of elastomer substrate/stretchable graphene-based layer/elastomer substrate. The laminate structure may include two or more, three or more, four or more, etc. of such substructures. The laminate structure may include a plurality of such substructures. According to one aspect, the layered structure may be produced by attaching the stretchable graphene-based layer to each substrate as described herein. Exemplary substrate materials include those as described herein. According to one aspect, the stretchable graphene-based layer can be placed on, and attached to, a first polymer substrate as described herein. A second polymer substrate can be pressed on, and attached to, the stretchable graphene-based layer. According to one aspect, the second polymer layer may be formed by being polymerized in situ on the surface of the stretchable graphene-based layer. In situ polymerization methods are known to those of skill in the art. According to one aspect, a liquid polymerization system including polymerizable compounds such as monomers or macromers and a polymerization initiator is appropriate can be placed on the stretchable graphene-based layer and then polymerized or cured in situ into a polymer layer. According to this aspect, the liquid polymerization system infiltrates the wrinkles or texture of the stretchable graphene-based layer and when cured or polymerized, interlocks the polymer layer to the stretchable graphene-based layer.

According to one aspect, many traditional barrier materials are not stretchable, but rather fail under modest tensile strain or develop pores or cracks that degrade barrier function. See Gamier, G. et al. Interest and durability of multilayers: from model films to complex films. Polymer. Adv. Tech. 22, 847-856, (2011). Also, common polymer-based barrier materials are not chemically resistant to the full spectrum of target permeants which include organic liquids that dissolve or swell the polymer matrix. High grade polymer barriers with high durability are normally heavyweight films that sacrifice mechanical flexibility. The present disclosure further recognizes that traditional functionalized graphene films or graphene oxide films deposited on a substrate are flexible and bendable with respect to the substrate on which they are placed, but do not exhibit desirable stretchability or elongation properties.

According to the present disclosure, stretchable graphene-based barrier layers are provided for use with stretchable substrates as a desirable feature in applications, including protective fabrics, wearable electronics, packaging/encapsulation of complex shapes or mechanically dynamic devices, lightweight inflatables, and stretch wrapping. According to one aspect, the substrate on which the stretchable graphene-based barrier layer is provided is itself stretchable, such as an elastomeric film. Such stretchable substrates may themselves be poor barriers. The present disclosure provides such stretchable substrates which may be poor barriers with a stretchable graphene-based barrier layer.

According to one aspect, stretchable graphene-based barrier layers are provided which are pre-compressed into a wrinkled or folded or textured state including many random wrinkles or folds and are capable of being stretched, such as when placed on a stretchable substrate, into a more expanded or unfolded or nontextured or relaxed or planar or smoother or flat state. According to one aspect, the graphene-based barrier layer may return to a wrinkled or folded or textured state, such as when the substrate is returned to a non-stretched state. According to one aspect, the stretchable graphene-based barrier layers possess desirable barrier properties as described herein and retain the desirable barrier properties while in the stretched state and after being repeatedly stretched and relaxed.

According to one aspect, a wrinkled, folded or textured graphene-based barrier layer which is stretchable is created by placing a planar, nonwrinkled, nonfolded or nontextured graphene-based barrier layer or a composition as described herein which forms the planar, nonwrinkled, nonfolded or nontextured graphene-based barrier layer onto a stretched elastomeric substrate followed by relaxation of the substrate to an original non-stretched state, thereby allowing the resulting surface of the graphene-based barrier layer to deform into a wrinkled, folded or textured state. In this manner, the stretched substrate forms a compressed graphene-based barrier layer. The compressed graphene-based barrier layer may be compressed along one dimension, i.e. X dimension or along two dimensions, i.e, the X and Y dimensions. According to one aspect, a planar substrate may be stretched along one dimension, such as the length of the substrate. The nontextured graphene-based barrier layer may be placed on and attached to the substrate stretched along one dimension and the substrate may then be relaxed forming a graphene-based barrier layer with wrinkles formed from the relaxation of the substrate along the one dimension, i.e the graphene-based barrier layer is compressed along one dimension. According to one aspect, a planar substrate may be stretched along two dimensions, such as the length and width of the substrate. The nontextured graphene-based barrier layer may be placed on and attached to the substrate stretched along two dimensions and the substrate may then be relaxed forming a graphene-based barrier layer with a crumpled texture formed from the relaxation of the substrate along the two dimensions, i.e the graphene-based barrier layer is compressed along two dimensions. According to this aspect, the relaxed substrate can then be stretched and the wrinkled, folded or textured graphene-based barrier layer will stretch along with the substrate along one or two dimensions while maintaining its barrier properties.

According to one aspect, a wrinkled or crumpled textured substrate may be further processed to increase the nature of the wrinkles or crumpled texture. For example, a planar substrate may be stretched along one dimension, such as the length of the substrate, i.e. stretching in the X direction. The previously wrinkled graphene-based barrier layer may be placed on and attached to the substrate stretched along one dimension and the substrate may then be relaxed forming a second generation graphene-based barrier layer with additional or modified wrinkles formed from the relaxation of the substrate along the one dimension. According to one aspect, a planar substrate may be stretched along two dimensions, such as the length and width of the substrate, i.e., stretching in the X and Y directions. The previously crumpled textured graphene-based barrier layer may be placed on and attached to the substrate stretched along two dimensions and the substrate may then be relaxed forming a second generation graphene-based barrier layer with additional or modified crumpled texture formed from the relaxation of the substrate along the two dimensions. According to certain aspects, the three dimensional surface characteristics may be designed or tailored as desired using various combinations of prestretched substrates with nonwrinkled or nontextured or noncrumpled graphene-based barrier layers or with previously wrinkled or textured or crumpled graphene-based barrier layers. According to this aspect, the relaxed substrate can then be stretched and the wrinkled, folded or textured graphene-based barrier layer will stretch along with the substrate while maintaining its barrier properties. Such an embodiment may be referred to as being “untrastretchable” insofar as several, or multiple or a plurality of compressions along one or more X or Y directions may be used to increase the ability of the graphene-based barrier layer to be stretched.

In particular, a large-area graphene oxide (GO) film is deposited onto a pre-stretched latex substrate, followed by a biaxial contraction for the creation of bilayer GO-latex materials, which can be exerted as ultrastretchable chemical barriers. A graphene-based barrier produced in this manner can be reversibly expanded to 1600% of its compressed area over 500 times and still resist a wide range of target permeants such as organic solvents.

According to one aspect, the wrinkled, folded or textured graphene-based barrier layer may be removed from the substrate used to create it and then adhered to a non-stretched elastomeric substrate. According to this aspect, the non-stretched elastomeric substrate can then be stretched and the wrinkled, folded or textured graphene-based barrier layer will stretch along with the substrate it is adhered to while maintaining its barrier properties.

Methods of making and testing wrinkled, folded or textured graphene-based barrier layers are described as follows.

Materials.

Anhydrous acetone, chlorobenzene, chloroform, cyclohexane, dichloromethane (DCM), dimethyl sulfoxide (DMSO), ethanol, ethyl ether, hexane, hydrazine monohydrate, tetrahydrofuran (THF), trichloroethylene (TCE), were purchased from Sigma-Aldrich. Rubber-based balloon is purchased from Amazon (Zuru X-Shot). Laboratory nitrile gloves are bought from Kimberly-Clark Professional. Clear heat shrink films were bought from Grafix. Polydimethylsiloxane (PDMS) is made from SYLGARD® 184 silicone elastomer kit. All water was deionized (18.2 MΩ, mill-Q pore). All reagents were used as received without further purification.

Fabrication of Higher Dimensional Graphene Oxide (GO) Membranes.

Higher dimensional graphene oxide membranes can be produced using thermal actuation or pressure-driven deformation to construct a higher dimensional GO membrane that can sustain extreme mechanics of stretching and block wide-range organic solvents. GO suspensions were prepared by a modified Hummer's method, purified, and characterized. The concentration of stock GO suspension is about 2.3 mg mL⁻¹, and a C/O atomic ratio of approximately 1.8. Different concentrations of GO suspensions were prepared by diluting with water.

According to one aspect, thermal actuation is used to create the wrinkled graphene-based barrier layers by using thermally responsive polymer substrates (i.e., shrink film). Shrink film was cut into 36 cm² squares and washed with ethanol. Once dry, samples were treated with pure oxygen plasma in a Deiner Atto Standard Olasma System. The chamber pressure was pumped down to and was maintained at 0.13 mbar. Plasma was then generated at 100% power (50 W) for 15 minutes followed by slow venting of the chamber. Next, 150 μL of GO suspension was drop-cast onto the substrates. Once dry, the planar GO films were obtained, and the samples were placed and allowed to shrink in an oven at 140° C. for 15 minutes. The sample was shrunk without any clamps or constrains and exhibited disordered crumple-like structures.

According to one aspect, pressure-induced deformation on a GO membrane was used to create the wrinkled graphene-based barrier layers. After the planar GO films were obtained on polystyrene shrink film, the polystyrene substrate was dissolved in DCM and wash the detached GO films with DCM, acetone, and ethanol sequentially. The free-standing GO membranes are then transferred onto a plasma-treated balloon inflated with different amount of water. After drying at room temperature, the balloon was then deflated and the upper layer of GO can be deformed into highly convoluted, i.e. crumpled, wrinkled, folded, etc., structures.

Preparation of Chemically Reduced GO (rGO).

Hydrazine dilute solution (2 wt. %) was prepared and stirred overnight. The planar and crumpled GO structures were immersed fully in the hydrazine solution, the reduction was allowed to proceed at 80° C. for 12 hours, and a dark brown-colored rGO film was produced. The rGO structures were sequentially rinsed with water and ethanol and dried in an oven at 70° C.

Characterizations.

Surface morphology of the multigenerational GO structures was investigated using a field emission scanning electron microscope (SEM) (LEO 1530 VP) operating at 10.0 kV for low-, medium- and high-resolution imaging. Before the SEM imaging, hierarchical GO structures were coated with a layer of AuPd (˜2 nm).

Preparation of a Wrinkled Graphene-Based Barrier Layer.

A stretchable graphene-based, for example graphene oxide, molecular barrier was created by depositing a pre-stacked planar multilayer GO film onto a pre-stretched elastomeric substrate followed by relaxation, allowing the resulting surface instability to deform the planar film into the wrinkled, stretchable dimension. An aqueous stock suspension containing monolayer GO sheets with lateral dimension from 0.5-5 μm was first drop-cast and air-dried on a polystyrene (PS) substrate, forming a GO thin film with planar morphology. The thickness of the GO film can be adjusted by the concentration of GO dispersion. The PS substrate was dissolved in dichloromethane (DCM) to detach the GO film. A free-standing GO film was obtained after sequential rinsing steps. The free-standing film was transferred as a patch onto an inflated latex balloon serving as a model for a general elastomeric substrate to be enhanced by the active barrier layer. The pre-strain and total contraction were controlled by the volume of water or air in the inflated state. Treatment of the latex by 02 plasma was used to achieve an adherent conformal patch.

The topographical features of a wrinkled or crumpled GO structure can be systematically controlled by altering the extent of substrate contraction and the thickness of GO film. The area-contraction-ratio can be programmed from 7.5 to 16.0 by controlling the inflated volume from 75 to 275 cm³, resulting in a wrinkled or crumpled GO structure with an average texture length scale (1) ranging from 0.7 to 1.2 μm, respectively. The crumpled texture is isotropic with a length scale approximated by λ=2πh(E_{c}/3Eₛ)^{1/3} where h is the GO thickness and the plane-strain elastic modulus Eᵢ=Eᵢ/(1−νᵢ²) is given in terms of the Young's modulus E and Poisson's ratio νᵢ of the coating (c) or latex substrate (s), respectively. Therefore, as the GO film thickness increases from 0.2 to 1.2 μm, the texture length scales increases from 1.1 to 5.5 μm (under the area-contraction-ratio at 16).

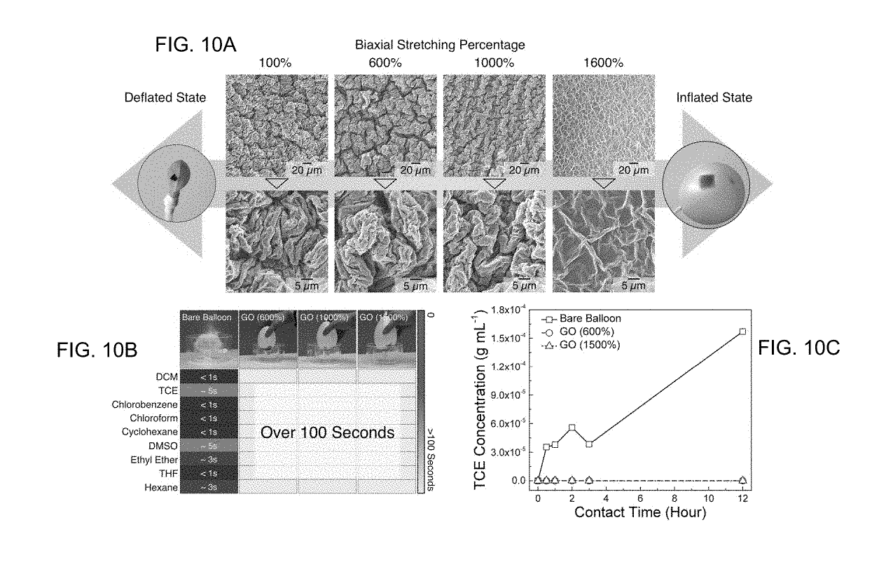

This conformal GO coating exhibits extreme stretchability and high mechanical stability. FIG. 10A shows a continuous evolution of the GO coating (wrinkled to less wrinkled) from a deflated state of the latex balloon to inflating the latex balloon to several stages. As the latex balloon was gradually inflated to 275 cm³, the superficial area of the GO coating increased about 16 times from 0.25 cm² (deflated state) to 4 cm² (inflated state). The crumpled features unfolded and texture length scale increased from 2.5 to 10 μm with reduction in Z-amplitude. The conformal GO coating was subjected to 100-500 cycles of inflation/deflation during which changes in the relaxed state topography were not observed. The interlayer spacing by XRD also remained unchanged constant during stretching and relaxation.

Having established that the stretchable graphene-based barrier layers can withstand repeated stretching and relaxation, the wrinkled or textured GO films were evaluated for molecular barrier properties after extreme deformation associated with stretching/contraction at these high area ratios using a latex balloon/patch test. The latex balloon/patch test determines permeation by organic liquids known to dissolve or weaken the underlying elastomer and burst the balloon. FIG. 10B depicts the barrier performance of stretchable GO-latex layered composites under nine chemical compounds and three stretching states. The balloons without the wrinkled stretchable graphene-based barrier layer burst within 5 seconds after contact with the chemical bath. The balloons with the protective wrinkled stretchable graphene-based barrier layer survive under direct contact with nine organic solvents under extreme balloon expansion.

The performance of stretchable GO-based barriers was also investigated for quantitative permeation using trichloroethylene (TCE) as a permeant and analyte, which is small-molecule industrial solvent (kinetic diameter˜5.6 Å) and important persistent and volatile environmental toxicant. The GO-based barriers were stretched to 600% and 1500% of their deflated dimension and brought into direct contact with a liquid TCE bath over 12 hours. The water reservoir on the back side of the barrier was collected for gas chromatography at different time points to quantify TCE permeation. As shown in FIG. 10C, TCE can easily permeate through latex to give measurable concentrations in the receiving water reservoir, while the stretchable GO membrane effectively blocks this permeation at all stages of stretching/relaxation.

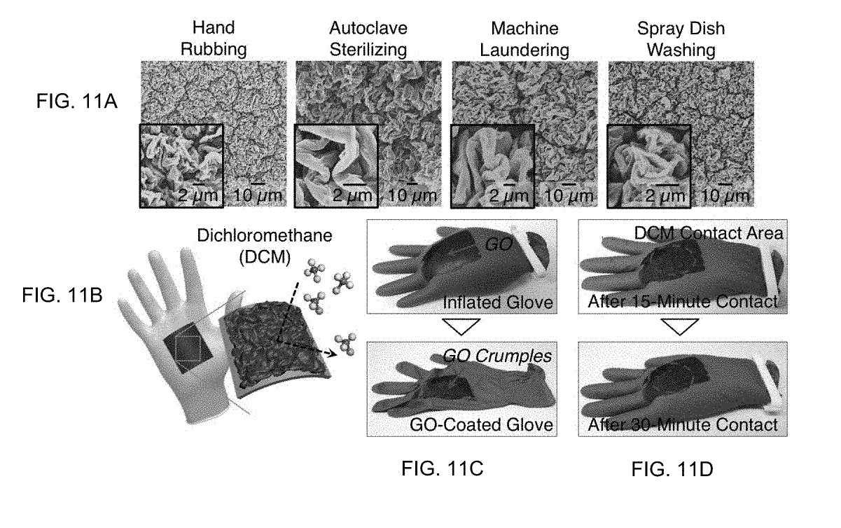

The stretchable graphene-based barrier layers were tested for durability insofar as the layers are contemplated for use in gloves and suits to protect wearers from a toxic chemical environment. As shown in FIG. 11A, the stretchable graphene-based barrier films were found to be intact after hand rubbing, autoclave sterilizing, machine laundering, and spray washing as models of mechanical stresses occurring during use and cleaning operations.

Stretchable GO membranes are envisioned as protective layers in next-generation protective fabrics, such as a glove as shown in FIG. 11B, for use in both civilian and military settings. According to this aspect and as shown in FIG. 11C, a general-purpose nitrile glove was inflated to a larger-than-normal size prior to transfer of a large-area GO patch. Deflation led to a crumple-textured GO patch conformally adhered on the outer surface. As shown in FIG. 11C, the stretchable GO membrane acts as a barrier against dichloromethane (DCM), a common industrial extraction solvent. With the textured GO layer, the glove can withstand direct contact with bulk liquid DCM for over 30 minutes without penetration.

### Example VII

### Embodiments

Aspects of the present disclosure are directed to a method of making a stretchable barrier article including (a) contacting a liquid solution of graphene-based sheets to a stretched elastomeric substrate, (b) drying the liquid solution to produce a smooth and continuous graphene-based layer adhered to the surface of the stretched elastomeric substrate, wherein the smooth and continuous graphene-based layer is substantially impermeable to transmission of small molecules through the graphene-based layer, and (c) relaxing the stretched elastomeric substrate to produce a compressed or wrinkled or crumpled or textured graphene-based barrier layer which is substantially impermeable to transmission of small molecules through the graphene-based layer. According to one aspect, the step of drying the liquid solution is carried out by heating the liquid solution. According to one aspect, the step of drying the liquid solution is carried out by heating the liquid solution to a temperature of between about 30° C. and about 80° C. According to one aspect, the step of drying the liquid solution is carried out by vacuum to remove the liquid. According to one aspect, the method further includes the step of cross-linking the graphene-based sheets forming the smooth and continuous graphene-based layer with a cross-linker. According to one aspect, the compressed or wrinkled or crumpled or textured graphene-based barrier layer includes graphene, graphene oxide or reduced graphene oxide. According to one aspect, the substrate is wearable by an individual. According to one aspect, the compressed or wrinkled or crumpled or textured graphene-based barrier layer includes graphene-based planar sheets aligned substantially parallel to one another and having substantially contiguous overlapping planar sheet faces. According to one aspect, the compressed or wrinkled or crumpled or textured graphene-based barrier layer includes graphene-based sheets aligned substantially parallel to one another and having substantially contiguous overlapping planar sheet faces forming a layer thickness of between about 5 nm and about 200 nm. According to one aspect, the compressed or wrinkled or crumpled or textured graphene-based barrier layer includes cross-linked graphene-based planar sheets. According to one aspect, the method further includes the step of surface treating the substrate before step (a). According to one aspect, the method further includes the step of surface treating the substrate before step (a) to enhance adherence of the graphene-based layer to the substrate. According to one aspect, the surface of the substrate before step (a) is a treated surface. According to one aspect, the surface of the substrate before step (a) is a treated surface enhancing adherence of the graphene-based layer to the substrate. According to one aspect, the graphene-based layer has an interlayer spacing of between about 0.34 nm and about 2.0 nm. According to one aspect, the graphene-based layer has an interlayer spacing of between about 0.4 nm and about 2.0 nm. According to one aspect, the graphene-based layer has an interlayer spacing of between about 0.4 nm and about 1.5 nm. According to one aspect, the graphene-based layer has an area density of between about 20 mg/m² and about 50 mg/m². According to one aspect, the graphene-based layer includes between 1 and about 50 layers of graphene-based planar sheets aligned substantially parallel to one another and having substantially contiguous overlapping planar sheet faces. According to one aspect, the method further includes the step of adding a second elastomer substrate to the surface of the compressed or wrinkled or crumpled or textured graphene-based barrier layer. Aspects of the present disclosure are directed to a barrier article including a substrate and a compressed or wrinkled or crumpled or textured graphene-based barrier layer adhered to the surface of a stretchable elastomeric substrate, wherein the compressed or wrinkled or crumpled or textured graphene-based barrier layer is substantially impermeable to transmission of a small molecule through the compressed or wrinkled or crumpled or textured graphene-based barrier layer. According to one aspect, the compressed or wrinkled or crumpled or textured graphene-based barrier layer includes graphene, functionalized graphene, graphene oxide or reduced graphene oxide. According to one aspect, the substrate is wearable by an individual. According to one aspect, the compressed or wrinkled or crumpled or textured graphene-based barrier layer includes graphene-based planar sheets aligned substantially parallel to one another and having substantially contiguous overlapping planar sheet faces. According to one aspect, the compressed or wrinkled or crumpled or textured graphene-based barrier layer includes graphene-based sheets aligned substantially parallel to one another and having substantially contiguous overlapping planar sheet faces forming a layer thickness of between about 5 nm and about 200 nm. According to one aspect, the compressed or wrinkled or crumpled or textured graphene-based barrier layer includes cross-linked graphene-based planar sheets. According to one aspect, the surface of the stretchable elastomeric substrate is a treated surface. According to one aspect, the surface of the stretchable elastomeric substrate is a treated surface enhancing adherence of the compressed or wrinkled or crumpled or textured graphene-based barrier layer to the substrate. According to one aspect, the compressed or wrinkled or crumpled or textured graphene-based barrier layer has an interlayer spacing of between about 0.34 nm and about 2.0 nm. According to one aspect, the compressed or wrinkled or crumpled or textured graphene-based barrier layer has an interlayer spacing of between about 0.4 nm and about 2.0 nm. According to one aspect, the compressed or wrinkled or crumpled or textured graphene-based barrier layer has an interlayer spacing of between about 0.4 nm and about 1.5 nm. According to one aspect, the compressed or wrinkled or crumpled or textured graphene-based barrier layer has an area density of between about 20 mg/m² and about 50 mg/m². According to one aspect, the compressed or wrinkled or crumpled or textured graphene-based layer includes between 1 and about 50 layers of graphene-based planar sheets aligned substantially parallel to one another and having substantially contiguous overlapping planar sheet faces. According to one aspect, the graphene-based planar sheets include functional groups. According to one aspect, the graphene-based planar sheets include oxygen containing functional groups. According to one aspect, the small molecule is a volatile organic compound or a semi-volatile organic compound. According to one aspect, the small molecule is benzene, toluene, xylenes, polyaromatic compounds, solvents including perchloroethylene, trichloroethylene, methylenechloride, methyl tertiary butyl ether, mycotoxins, phthalates, bisphenol A, inks containing benzophenone or 1-benzoylcyclohexanol or 2-hydroxy-2-methylpropiophenone, 2-methylpentane, 3-methylpentane, hexane, methylcyclopentane, cyclohexane, BHT and compounds used in polymer, ink, and adhesive formulations, mercury, mercury vapor, chromium, lead, oxygen, formaldehyde, aromatic hydrocarbons, trichloroethylene, perchloroethylene, soil fumagants, radon, chemical and biological agents used in military applications, corrosive vapors such as HCl, HF, HNO3 or other acids or bases and toxic or odor-generating vapors from contaminated sites or landfills. According to one aspect, the barrier articles further includes a second elastomer substrate attached to the surface of the compressed or wrinkled or crumpled or textured graphene-based barrier layer.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. While the invention has been illustrated and described in detail in the drawings and foregoing description, such illustration and description is to be considered as exemplary and not restrictive in character, it being understood that, only the preferred embodiments have been shown and described and that all changes and modifications that come within the spirit of the invention are desired to be protected. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc. References identified herein are expressly incorporated herein by reference in their entireties unless otherwise indicated.

1. A method of making a stretchable barrier article comprising
(a) contacting a liquid solution of graphene-based sheets to a stretched elastomeric substrate,
(b) drying the liquid solution to produce a smooth and continuous graphene-based layer adhered to the surface of the stretched elastomeric substrate, wherein the smooth and continuous graphene-based layer is substantially impermeable to transmission of small molecules through the graphene-based layer, and
(c) relaxing the stretched elastomeric substrate to produce a compressed or wrinkled or crumpled or textured graphene-based barrier layer which is substantially impermeable to transmission of small molecules through the graphene-based layer.

2. The method of claim 1 wherein the step of drying the liquid solution is carried out by heating the liquid solution.

3. The method of claim 1 wherein the step of drying the liquid solution is carried out by heating the liquid solution to a temperature of between 30° C. and 80° C.

4. The method of claim 1 wherein the step of drying the liquid solution is carried out by vacuum to remove the liquid.

5. The method of claim 1 further including the step of cross-linking the graphene-based sheets forming the smooth and continuous graphene-based layer with a cross-linker.

6.-10. (canceled)

11. The method of claim 1 further including the step of surface treating the substrate before step (a).

12. The method of claim 1 further including the step of surface treating the substrate before step (a) to enhance adherence of the graphene-based layer to the substrate.

13. The method of claim 1 wherein the surface of the substrate before step (a) is a treated surface enhancing adherence of the graphene-based layer to the substrate.

14. The method of claim 1 wherein the surface of the substrate before step (a) is a treated surface enhancing adherence of the graphene-based layer to the substrate.

15.-19. (canceled)

20. A barrier article comprising
a substrate and
a compressed or wrinkled or crumpled or textured graphene-based barrier layer adhered to the surface of a stretchable elastomeric substrate, wherein the compressed or wrinkled or crumpled or textured graphene-based barrier layer is substantially impermeable to transmission of a small molecule through the compressed or wrinkled or crumpled or textured graphene-based barrier layer.

21. The barrier article of claim 20 wherein the compressed or wrinkled or crumpled or textured graphene-based barrier layer includes graphene, functionalized graphene, graphene oxide or reduced graphene oxide.

22. The barrier article of claim 20 wherein the substrate is wearable by an individual.

23. The barrier article of claim 20 wherein the compressed or wrinkled or crumpled or textured graphene-based barrier layer includes graphene-based planar sheets aligned substantially parallel to one another and having substantially contiguous overlapping planar sheet faces.

24. The barrier article of claim 20 wherein the compressed or wrinkled or crumpled or textured graphene-based barrier layer includes graphene-based sheets aligned substantially parallel to one another and having substantially contiguous overlapping planar sheet faces forming a layer thickness of between 5 nm and 200 nm.

25. The barrier article of claim 20 wherein the compressed or wrinkled or crumpled or textured graphene-based barrier layer includes cross-linked graphene-based planar sheets.

26. The barrier article of claim 20 wherein the surface of the stretchable elastomeric substrate is a treated surface.

27. The barrier article of claim 20 wherein the surface of the stretchable elastomeric substrate is a treated surface enhancing adherence of the compressed or wrinkled or crumpled or textured graphene-based barrier layer to the substrate.

28. The barrier article of claim 20 wherein the compressed or wrinkled or crumpled or textured graphene-based barrier layer has an interlayer spacing of between 0.34 nm and 2.0 nm.

29. The barrier article of claim 20 wherein the compressed or wrinkled or crumpled or textured graphene-based barrier layer has an interlayer spacing of between 0.4 nm and 2.0 nm.

30. The barrier article of claim 20 wherein the compressed or wrinkled or crumpled or textured graphene-based barrier layer has an interlayer spacing of between 0.4 nm and 1.5 nm.

31. The barrier article of claim 20 wherein the compressed or wrinkled or crumpled or textured graphene-based barrier layer has an area density of between 20 mg/m² and 50 mg/m².

32. The barrier article of claim 20 wherein the compressed or wrinkled or crumpled or textured graphene-based layer includes between 1 and 50 layers of graphene-based planar sheets aligned substantially parallel to one another and having substantially contiguous overlapping planar sheet faces.

33. The barrier article of claim 20 wherein the graphene-based planar sheets include functional groups.

34. The barrier article of claim 20 wherein the graphene-based planar sheets include oxygen containing functional groups.

35. The barrier article of claim 20 wherein the small molecule is a volatile organic compound or a semi-volatile organic compound.

36. The barrier article of claim 20 wherein the small molecule is benzene, toluene, xylenes, polyaromatic compounds, solvents including perchloroethylene, trichloroethylene, methylenechloride, methyl tertiary butyl ether, mycotoxins, phthalates, bisphenol A, inks containing benzophenone or 1-benzoylcyclohexanol or 2-hydroxy-2-methylpropiophenone, 2-methylpentane, 3-methylpentane, hexane, methylcyclopentane, cyclohexane, BHT and compounds used in polymer, ink, and adhesive formulations, mercury, mercury vapor, chromium, lead, oxygen, formaldehyde, aromatic hydrocarbons, trichloroethylene, perchloroethylene, soil fumagants, radon, chemical and biological agents used in military applications, corrosive vapors such as HCl, HF, HNO₃ or other acids or bases and toxic or odor-generating vapors from contaminated sites or landfills.

37. The method of claim 1 further including the step of adding a second elastomer substrate to the surface of the compressed or wrinkled or crumpled or textured graphene-based barrier layer.

38. The barrier article of claim 20 further including a second elastomer substrate attached to the surface of the compressed or wrinkled or crumpled or textured graphene-based barrier layer.
